(19) United States
(12) Patent Application Publication
(10) Pub. No.: US 2011/0008572 A1
(43) Pub. Date: Jan. 13, 2011

(54) Device for Enhancing a Corner Structure

(76) Inventor: Connie M. Dayton, Ft. Worth, TX (US)

Correspondence Address: SLATER & MATSIL, L.L.P., 17950 PRESTON RD, SUITE 1000, DALLAS, TX, 75252-5793, US

(21) Appl. No.: 12/792,379

(22) Filed: Jun. 2, 2010

Related U.S. Application Data
(60) Provisional application No. 61/225,158, filed on Jul. 13, 2009.

(51) Int. Cl. B32B 3/02; B23P 17/00; B44F 3/00; E04F 19/02

(52) U.S. Cl. 428/119; 29/592; 428/192

(57) ABSTRACT

In an embodiment, an interchangeable corner hanger to ornament framing protruding corner structures is provided. The interchangeable corner hanger includes a horizontal portion and a vertical portion. The horizontal portion is designed to rest on an exposed edge of a corner structure, and the vertical portion is designed to hang over the corner of the corner structure and rest against a wall upon which the trim is attached. The vertical portion has a length sufficient to stabilize the corner hanger without the use of other adhesives or attachments.

This application claims the benefit of U.S. Provisional Application Ser. No. 61/225,158, filed on Jul. 13, 2009, entitled “Corner Hanger,” which application is hereby incorporated herein by reference.

### TECHNICAL FIELD

This invention relates generally to building structures and, more particularly, to interchangeable devices to ornament framing structures.

### BACKGROUND

Generally, framing structures, such as doors and windows, have a decorative piece of trim nailed into place. The trim services to cover gap between the wall and the framing structure, thereby providing a more aesthetically pleasing appearance. While the trim is more aesthetically pleasing, many times it is desirable to provide different appearances.

One solution to this is to replace the trim as desired. This solution, however, is difficult and time-consuming. Replacing the trim requires the trim to be cut to the precise size, nailing the trim in place, caulking the joints, and painting the trim and wall surfaces.

Another solution is placing a wallpaper-type border around the trim. This solution involves affixing a decorative strip with an adhesive. While this solution provides a decorative border, changing or removing the wallpaper-type border may also be difficult and time-consuming as the wallpaper-type border is affixed by glue.

Yet another solution is to paint a decorative scene directly on the wall itself around the trim. This solution is time-consuming to put up in the first place as well as replacing it. This solution may also be expensive if it is necessary to hire a painter to create the painting.

### SUMMARY

These and other problems are generally reduced, solved or circumvented, and technical advantages are generally achieved, by embodiments of the present invention, which provides interchangeable devices to ornament a framing structure.

In an embodiment, interchangeable corner hanger devices to ornament protruding corner structures are provided. The interchangeable corner hanger devices include a horizontal portion and a vertical portion. The horizontal portion is designed to rest on an exposed edge of the corner structure, and the vertical portion is designed to hang over the corner structure and rest against a wall upon which the corner structure is attached. The vertical portion has a length sufficient to stabilize the corner hanger without the use of other adhesives or attachments.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1-15 illustrate embodiments of corner hangers having various shapes.

### DETAILED DESCRIPTION

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

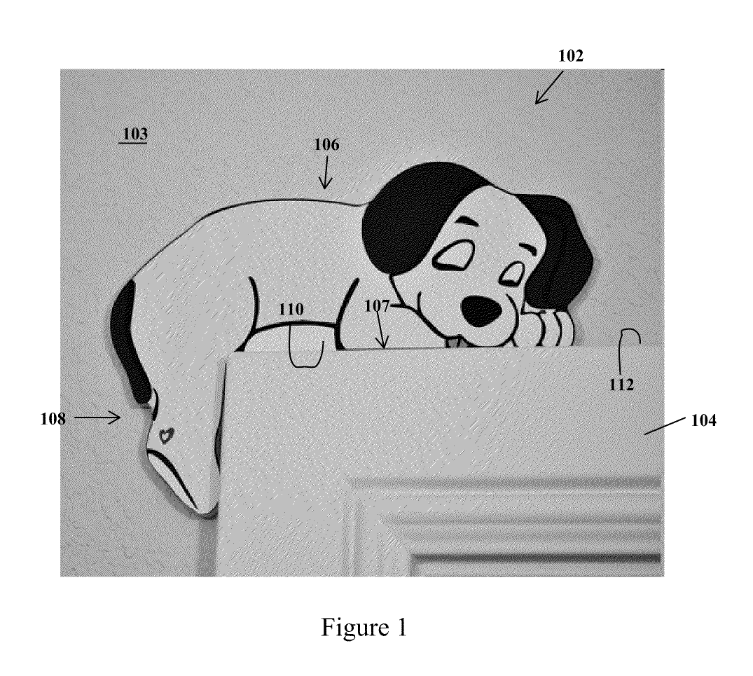

FIG. 1 illustrates an interchangeable corner hanger 102 placed on a corner structure 104 protruding from a supporting wall 103 in accordance with an embodiment, wherein the corner hanger 102 is shaped as a dog such that the leg of the dog hangs over a corner of the corner structure 104 to provide stability. In this embodiment, the corner structure 104 is illustrated as trim around a doorway for illustrative purposes only. In other embodiments, the corner structure 104 may be trim around a window, a mirror, a light plate switch, or the like. The corner hanger 104 may be formed of any suitable material, such as wood, plastic, or the like, and be of any suitable thickness. In an embodiment in which the corner structure 104 is trim around a doorway, the corner hanger 102 is formed of wood having a thickness of about one-eighth of an inch.

The corner hanger 102 has a horizontal portion 106 and a vertical portion 108. The horizontal portion 106 has one or more contact points 107 designed to rest upon an upper surface 112 of the corner structure 104. While the embodiment illustrated in FIG. 1 illustrates that substantially all of a bottom surface 110 of the corner hanger 102 contacts the upper surface 112 of the corner structure 104, in other embodiments, portions of the bottom surface 110 may have multiple contact points such that not all of the bottom surface 110 contacts the upper surface 112 of the corner structure 104.

The vertical portion 108 extends over a corner of the corner structure 104 and provides stability and balance to the corner hanger 102, allowing the corner hanger 102 to stay in place without need of fasteners, such as glue, Velcro, nails, screws, or the like. By extending a portion of the corner hanger 102 over the corner of the corner structure 104 in the manner illustrated in FIG. 1, the center of gravity is effectively lowered relative to the upper surface 112 of the corner structure 104. It has been found that in this manner, it allows the corner hanger 102 to remain in place, even over a door trim with the door being repeatedly slammed shut. Without the vertical portion 108, the center of gravity would be considerably higher and provides a much less stable structure. In an embodiment, the center of gravity is lower than about two inches above the upper surface 112 of the corner structure 104. For example, in an embodiment, the center of gravity is lower than the upper surface 112 of the corner structure 104.

The vertical portion 108 may further rest against the supporting wall 103, such that the supporting wall 103 provides an anti-tipping effect. As can be appreciated, a structure comprising only the horizontal portion has a fulcrum or point of rotation along a joint between the contact points 107 and the upper surface 112 of the corner structure 104 and, as a result, could easily tip over. The vertical extension of the vertical portion 108, however, restricts the tipping motion, because as the horizontal portion 106 tips, the vertical portion 108 is “pushed into” the wall. In this manner, as the wall prevents the vertical portion 108 from rotating into the wall, the horizontal portion 106 is prevented from tipping over.

It should be appreciated that the larger the vertical portion 108 is relative to the horizontal portion 106, the more stable the corner hanger 102 may be. Further, it should be noted that the vertical height of the horizontal portion 106 also affects the stability, wherein the greater the vertical height of the horizontal portion 106, the less stable. Accordingly, the greater the vertical height of the horizontal portion 106, it may be desirable to increase the size of the vertical portion 108.

Embodiments of the corner hanger 102 may be easily replaced to provide different themes to a room. For example, seasonal themes may be used for Valentine's Day, Easter, Christmas, Halloween, Fourth of July, Thanksgiving, and the like, throughout the year.

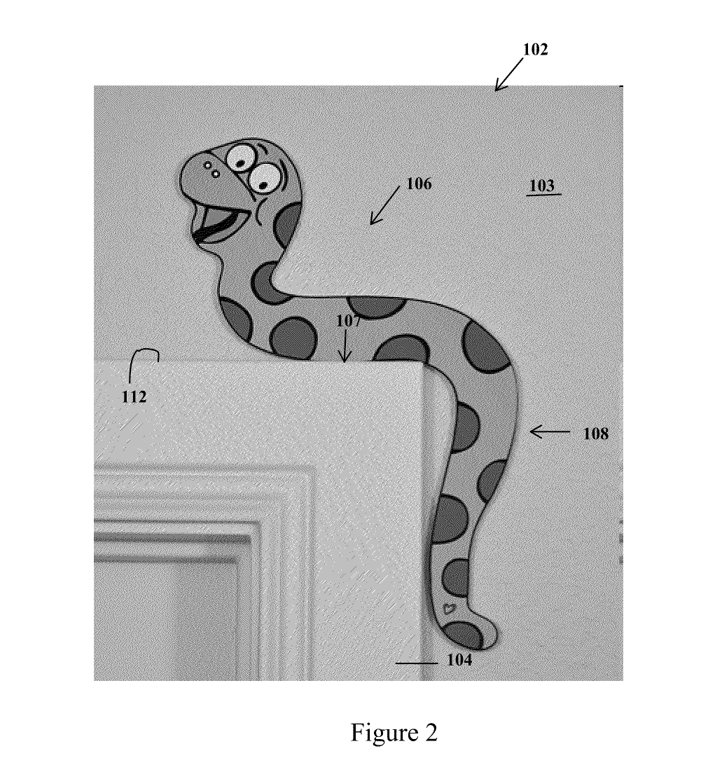

FIGS. 2-11 are examples of types of corner hangers that may be used in accordance with various embodiments. Referring first to FIG. 2, the corner hanger 102 has a shape of a snake, wherein the head of the snake is elevated above the upper surface 112 of the corner structure 104. Further, FIG. 2 illustrates that the entirety of the vertical portion 108 does not necessarily rest against the corner structure. For example, the curve of the snake around the corner of the corner structure 104 extends past the corner, thereby leaving a gap between the corner structure 104 and the corner hanger 102. The lower portion of the snake rests against the trim, thereby aiding in providing a solid, stable base.

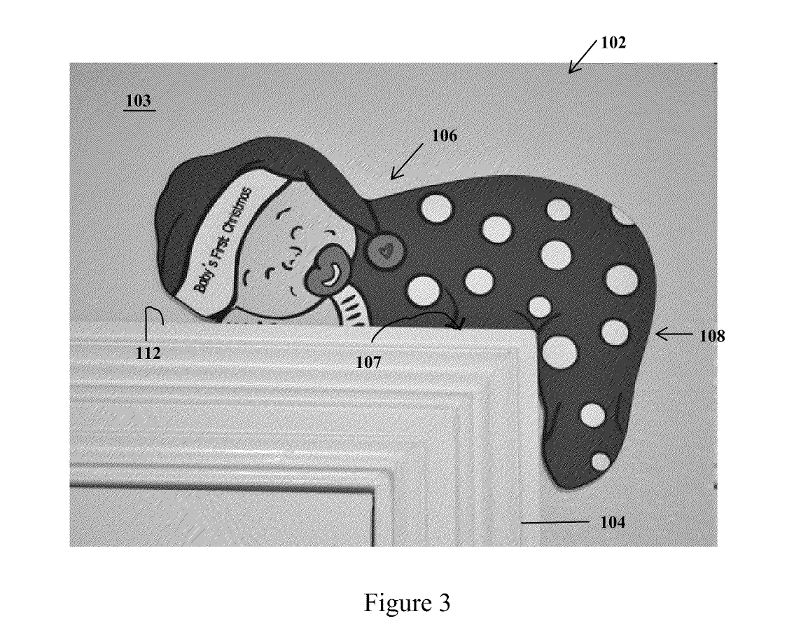

In FIG. 3, the corner hanger 102 has a shape of a sleeping baby, wherein a head and body of the sleeping baby rests on the upper surface 112 of the corner structure 104, and feet of the sleeping baby hang over the corner of the corner structure 104 to provide stability.

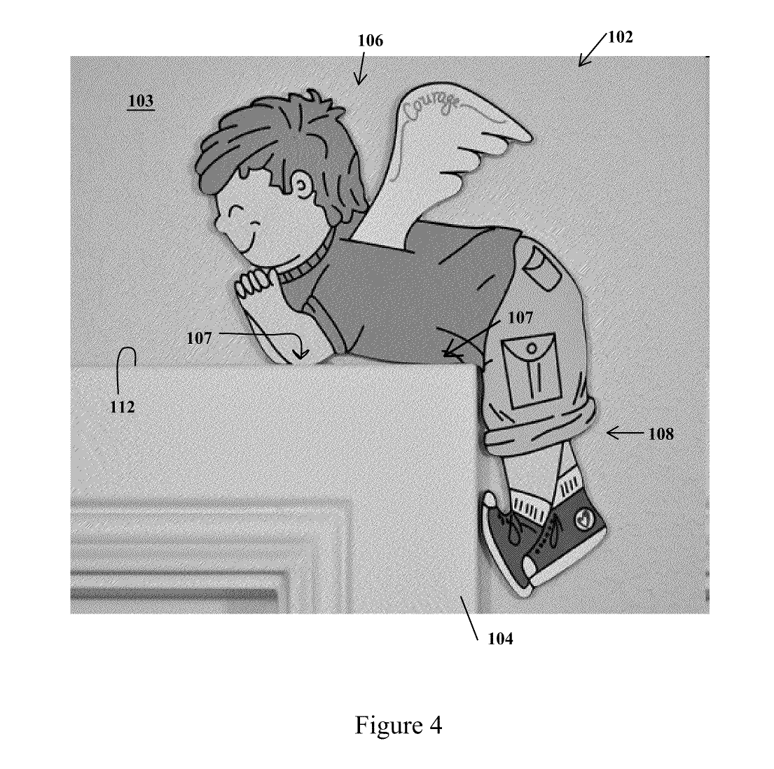

FIG. 4 illustrates the corner hanger 102 shaped as a boy with angel wings. Similar to the embodiment illustrated in FIG. 3, the legs hang over the corner of the corner structure 104 to provide support. FIG. 4 also illustrates an embodiment in which multiple contact points 107 are used for the interface between the horizontal portion 106 and the corner structure 104.

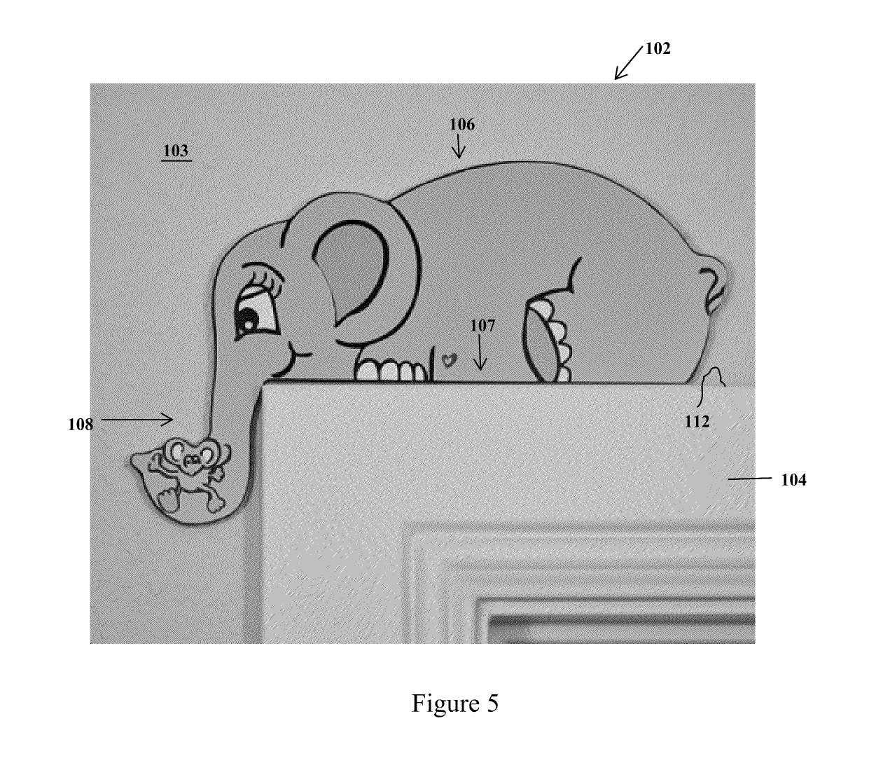

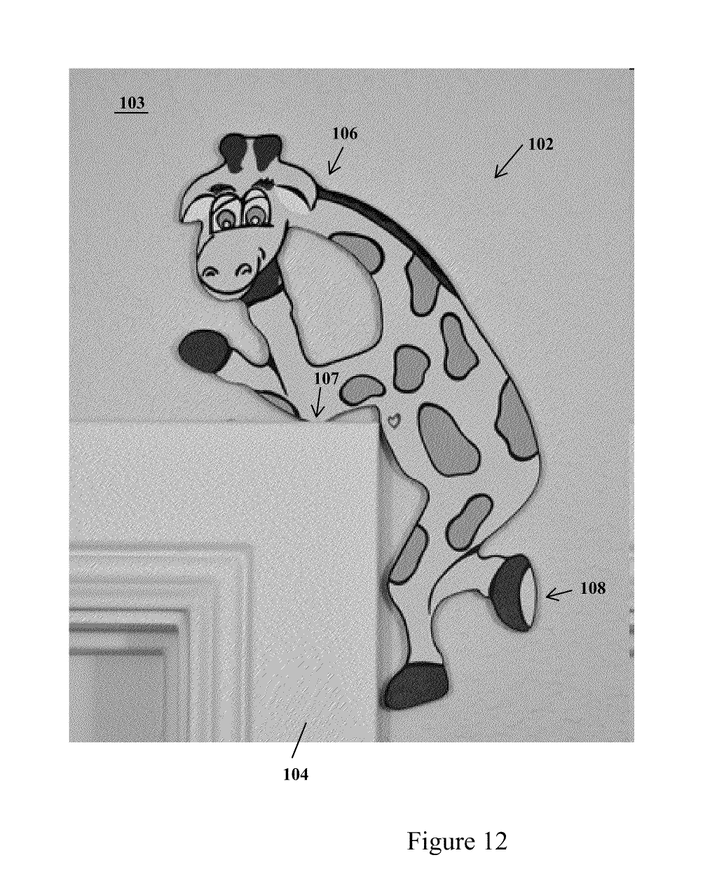

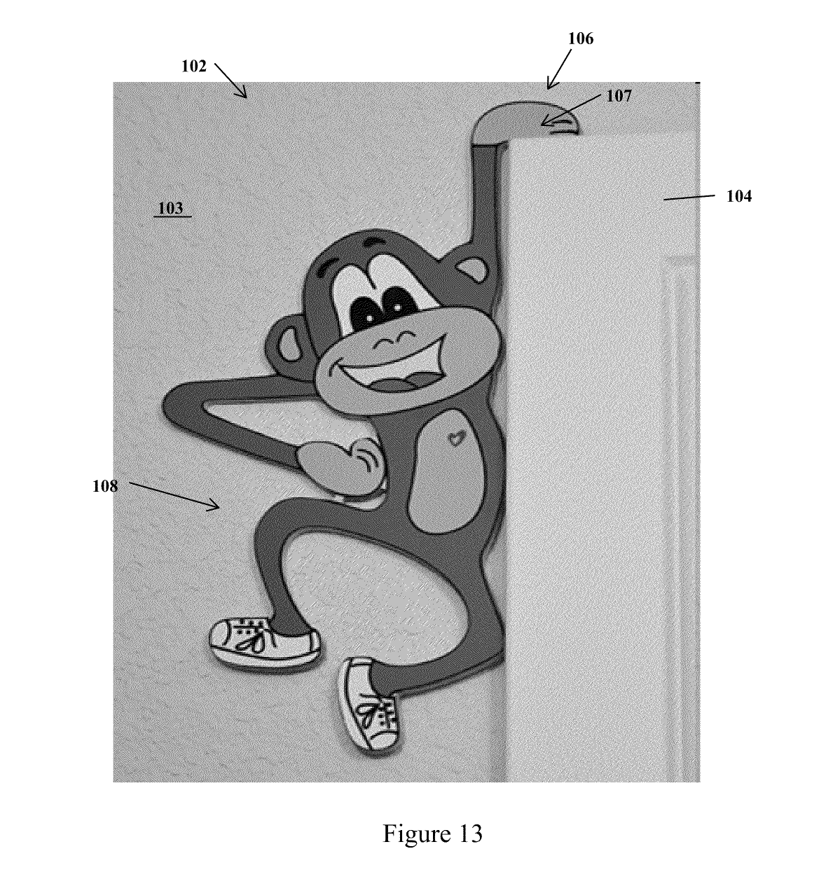

FIG. 5 illustrates the corner hanger 102 shaped as an elephant in which a trunk of the elephant hangs over the edge to provide support. FIG. 5 also illustrates that embodiments may be designed such that the vertical portion 108 does not directly contact portions of the corner structure 104. As illustrated below with reference to FIGS. 12 and 13, in some embodiments at least a portion of the vertical portion 108 contacts the corner structure 104.

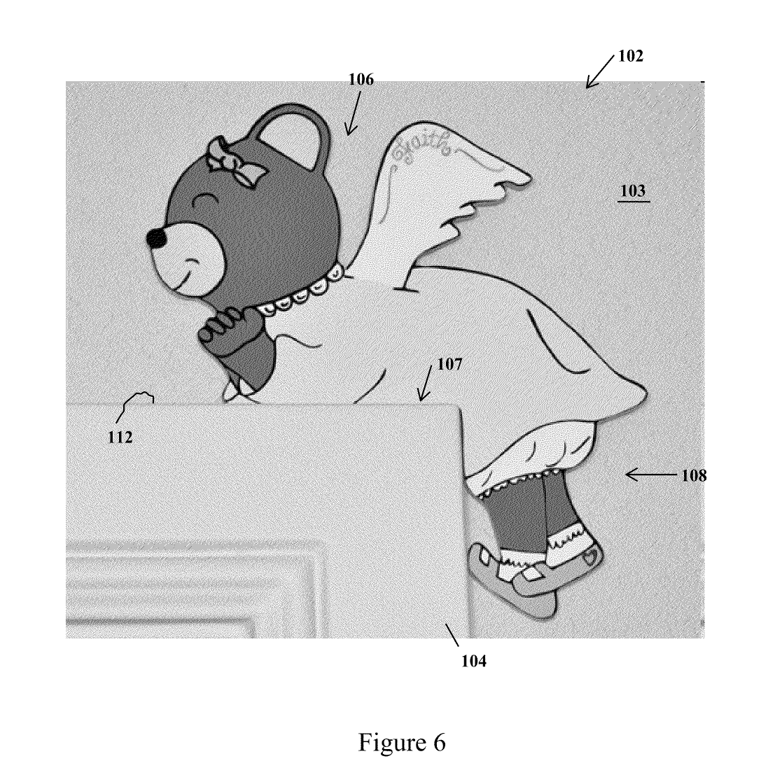

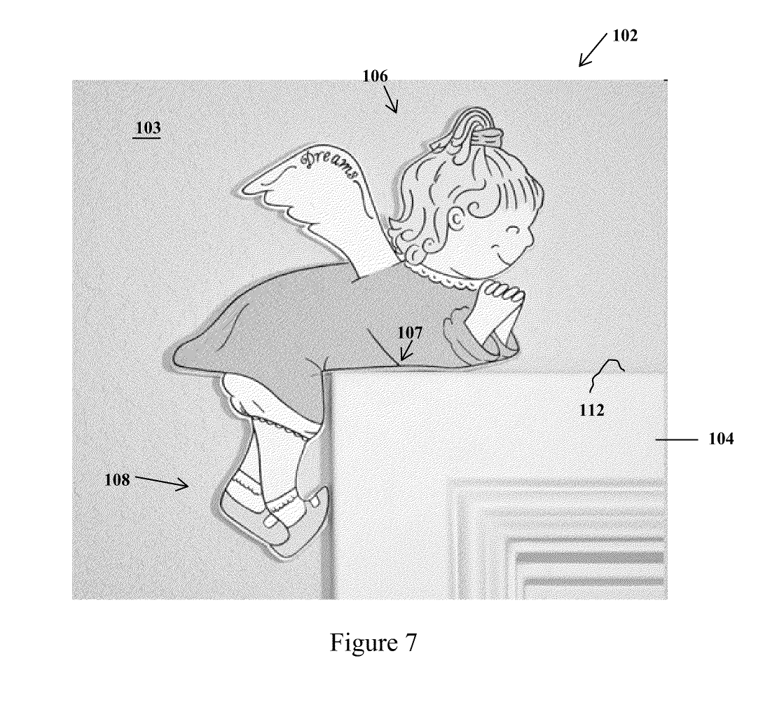

FIGS. 6 and 7 illustrate the corner hanger 102 as a bear and a girl, respectively, with angel wings. Similar to the embodiment illustrated in FIG. 4, the legs hang over the corner of the corner structure 104 to provide support.

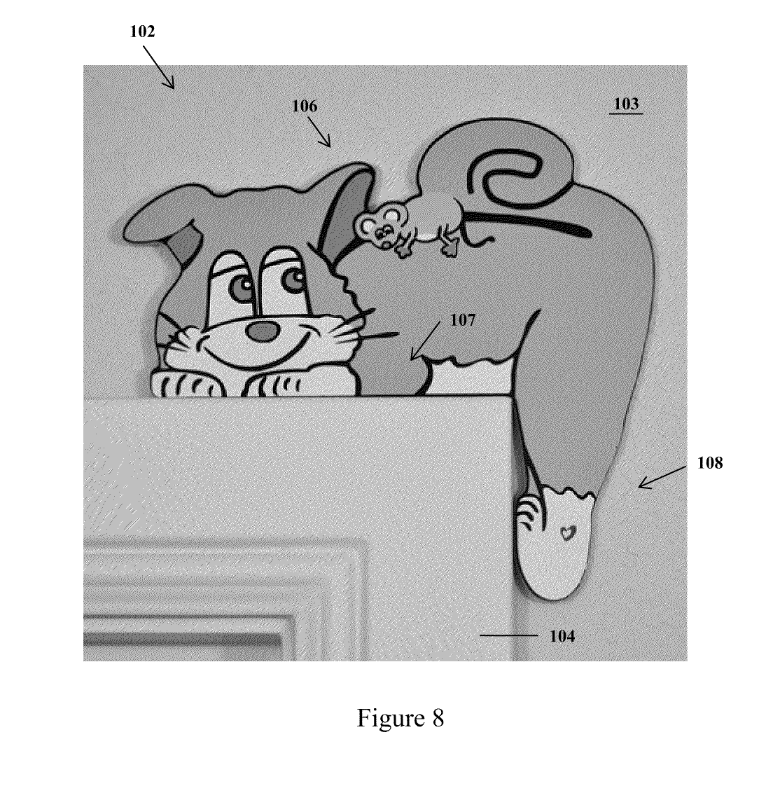

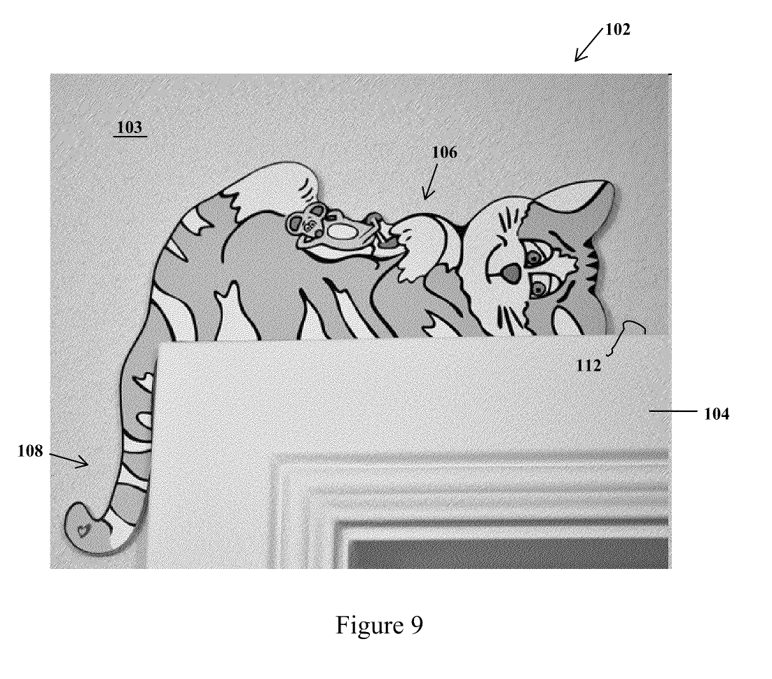

FIGS. 8 and 9 illustrate various corner hangers of a cat, wherein FIG. 8 is illustrated to hang from the right side and FIG. 9 is designed to hang from the left side. It should also be noted that the vertical portion of the cat in FIG. 8 comprises the back legs of the cat, while the vertical portion of the cat in FIG. 9 comprises the tail.

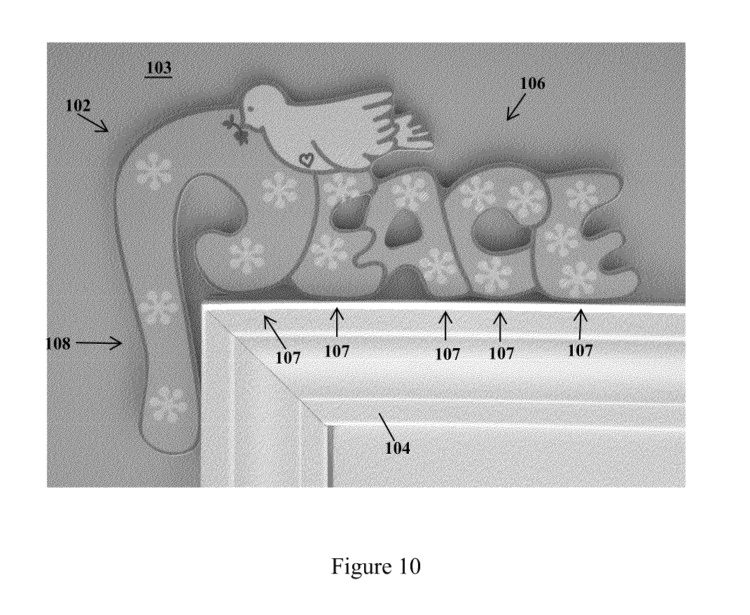

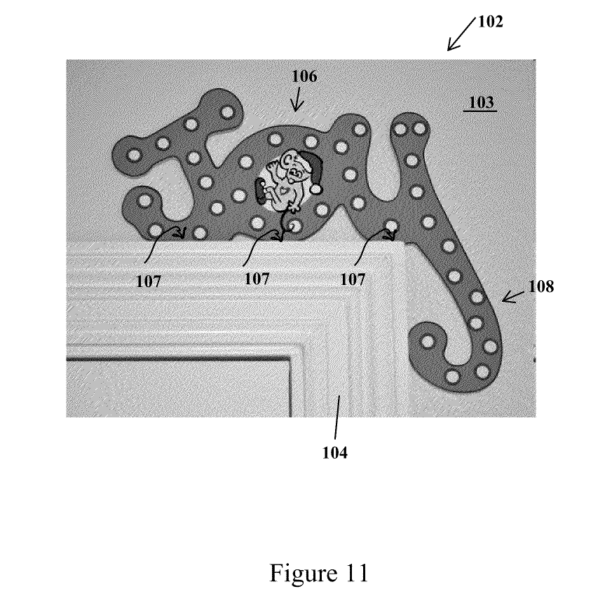

FIGS. 10 and 11 illustrate that embodiments of the corner hanger 102 may use shapes or configurations other than animals or people. For example, in the embodiment illustrated in FIG. 10, the word “Peace” is used, wherein the “P” hangs over the edge to provide stability. FIG. 10 further illustrates that a flat edge is not necessarily present to rest against the top surface of the corner structure 104. FIG. 11 illustrates a similar embodiment in which the corner hanger 102 is shaped as the word “Joy,” wherein the “y” hangs over the corner of the corner structure 104. In these embodiments, the corner hanger has multiple points of contact.

FIG. 12 illustrates the corner hanger 102 shaped as a giraffe. In this embodiment, the corner hanger 102 is designed such that the vertical portion 108 of the corner hanger 102 contacts the corner structure 104 to keep the corner hanger 102 from rotating and swinging off of the corner structure 104. In particular, the single, relatively small, contact point 107 of the giraffe acts as a point of rotation aided by the weight of the giraffe's body hanging over the corner of the corner structure. The giraffe rotates thus until the one or more portions of the vertical portion 108 of the giraffe contacts the corner structure 104.

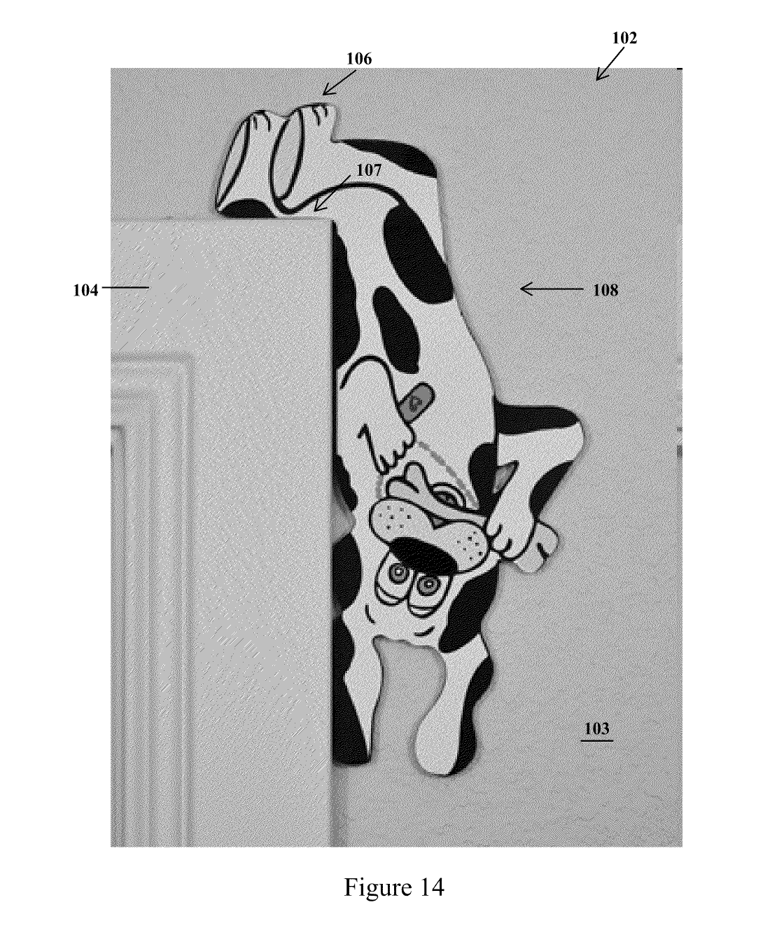

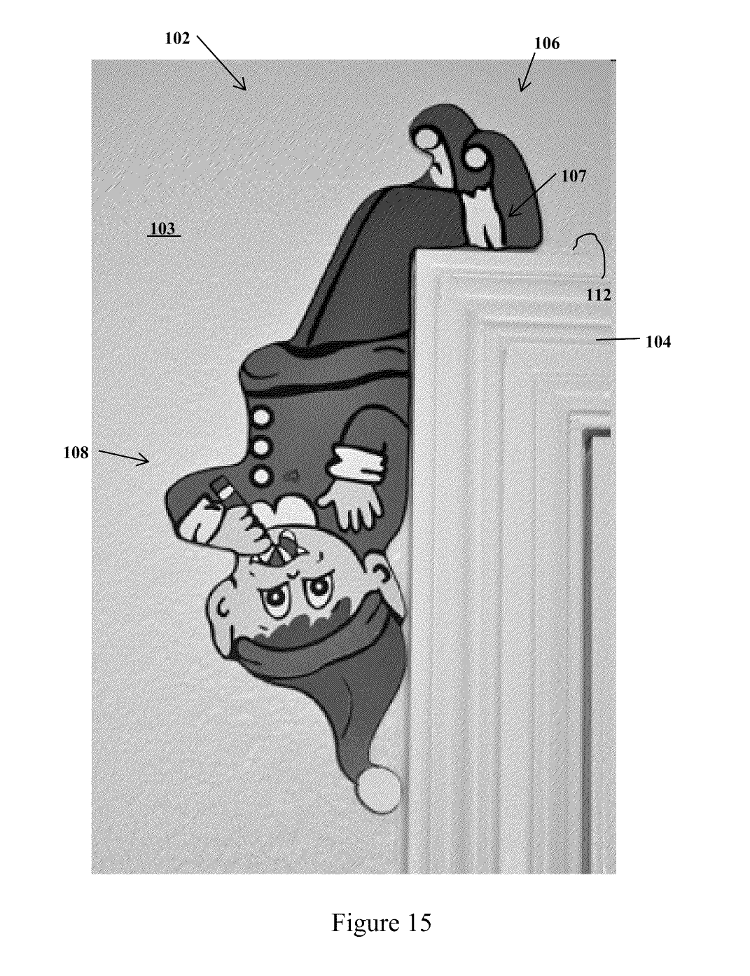

FIGS. 13-15 illustrate embodiments of the corner hanger 102 wherein the horizontal portion 106 is small compared to the overall size of the corner hanger 102. For example, in FIG. 13, the horizontal portion 106 comprises only a hand of a monkey, while remaining portions of the body of the monkey hang over the corner of the corner structure 104. Similarly, in FIG. 14, the dog is hanging by only the lower portions of the back legs of the dog, and in FIG. 15, an elf hangs only by the lower legs.

In embodiments such as those illustrated in FIGS. 12-15, the center of gravity is sufficiently close to the vertical surface of the corner structure 104 such that the corner hanger 102 does not rotate off the corner structure 104. For example, in an embodiment the center of gravity is within two inches of the vertical surface of the corner structure 104.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus for a corner of a structure, the corner having a horizontal surface and a vertical surface, the apparatus comprising:
a horizontal portion having one or more contact points for resting on a horizontal portion of the structure; and
a vertical portion connected to the horizontal portion, the vertical portion extending lower than the horizontal portion.

2. The apparatus of claim 1, wherein the corner is a 90-degree corner.

3. The apparatus of claim 1, wherein the apparatus has a center of gravity lower than a bottom surface of the horizontal position.

4. The apparatus of claim 1, wherein the structure is a door trim.

5. The apparatus of claim 1, wherein the structure is a window trim.

6. The apparatus of claim 1, wherein the structure is a light plate.

7. The apparatus of claim 1, wherein the vertical portion has one or more contact points bearing on the vertical surface of the trim.

8. The apparatus of claim 1, wherein the apparatus has one or more contact points bearing on a supporting wall.

9. A method of forming an apparatus, the method comprising:
forming a horizontal shape having one or more contact points on an exterior boundary arranged in a linear line for resting upon an upper surface of a structure; and
forming a vertical shape extending from the horizontal shape, the vertical shape extending lower than the one or more contact points.

10. The method of claim 9, wherein the structure is a 90-degree corner.

11. The method of claim 9, wherein the apparatus has a center of gravity lower than a bottom surface of the horizontal shape.

12. The method of claim 9, wherein the structure is a door trim.

13. The method of claim 9, wherein the structure is a window trim.

14. The method of claim 9, wherein the structure is a light plate.

15. The method of claim 9, wherein the vertical shape has one or more contact points bearing on a vertical surface of the structure.
